(19) United States
(12) Patent Application Publication
(10) Pub. No.: US 2008/0028065 A1
(43) Pub. Date: Jan. 31, 2008

(54) Application threat modeling

(75) Inventors: Erik Caso, Huntington Beach, CA (US); Mike Shema, San Francisco, CA (US); Dan A. Kuykendall, La Mirada, CA (US); JD Glaser, Irvine, CA (US)

Correspondence Address: CHARLES C.H. WU, 98 DISCOVERY, IRVINE, CA, 92618-3105, US

(73) Assignee: NT OBJECTIVES, INC.

(21) Appl. No.: 11/493,214

(22) Filed: Jul. 26, 2006

(51) Int. Cl. G06F 11/00; G06F 12/14; G06F 15/173; G06F 12/16; G06F 15/18; G08B 23/00

(52) U.S. Cl. 709/224; 726/25

(57) ABSTRACT

A method and system for analyzing data relating to a website including the content and architecture of the website are provided. All relevant site related information is cataloged. Then “attack points” or vectors used by a hacker within the site are determined. Based on the above, a calculation of a relevant level of security for each attack point is determined.

### BACKGROUND OF THE INVENTION

1. Field of the Invention

The invention pertains to the field of websites associated with a network such as the Internet. More particularly, the invention pertains to a high level application threat modeling of websites.

2. Description of Related Art

A search engine such as a crawler is known. A crawler is a program which visits and reads Web site page information in order to create entries for a search engine index. A crawler is also known as a “spider” or a “bot.” Crawlers are typically programmed to visit sites that have been submitted by their owners as new or updated sites. Entire sites or specific pages can be selectively visited and indexed.

Network Scanners are known. A “Network Scanner” is a technology that connects with many network servers and its ports, looking for network services with known vulnerabilities. This is done by using known “attacks” against the running services. U.S. Pat. No. 6,574,737 to Kingsford et al describes a computer network penetration test that discovers vulnerabilities in the network using a number of scan modules. The scan modules independently and simultaneously scan the network. A scan engine controller oversees the data fed and received from the scan modules which controls information sharing among the modules according to data records and configuration files that specify how a user-selected set of penetration objectives should be carried out. The system allows simultaneous and independent attempts for penetration strategies. Each strategy shares information with other strategies to increase effectiveness which, together, form a very comprehensive approach to network penetration. The strategies are able to throttle at different levels to allow for those that are more likely to achieve success to run at the highest speeds. While most strategies collect information from the network, at least one dedicated strategy will utilize a set of rules to analyze data produced by others. This analysis reduces and refines data which simplifies the design of the various strategies. Data obtained through the various strategies is stored in such a way that new data types can be stored and processed without adjusting the remaining strategies. Strategies are run depending on whether or not they help achieve a specified objective. The vulnerability scan is initiated by a user who specifies which targeted network resources to scan. The scan is now data driven, modeling how an unwanted attacker would gain unauthorized access to a system. The 737' patent does not operate at the application level, though. Using the OSI network model as a measure, the 737' patent operates at levels 4, 5, and 6 in addition to level 7. There are no known obvious or transferable techniques that work from layer 6 to layer 7.

There are other types of known network scanners. Typically a network scanner is neither a method nor technique involved with Web Application scanning. A “Network Scanner” is a technology that connects with many network servers and its ports, looking for network services with known vulnerabilities. This is done by using known “attacks” with packets constructed at level 6 of the network protocol stack.

Methods for verifying hyperlinks on a web site are known. U.S. Pat. No. 6,601,066 to Davis-Hall describes a method for verifying hyperlinks on a web site. The method includes generating a hyperlink database with a plurality of hyperlinks and uniform resource locators associated with each hyperlink. An Internet browser application is then initiated and the Internet browser application attempts to retrieve content in response to the uniform resource locator. Once either a presence or absence of an error is detected in retrieving the content, a web site administrator is notified of the results. The 066' patent crawls a website to verify good links. A database of known good links is key to the 066' patent The 066' patent tests a list of good and dead links (i.e. a link that goes to a non-existent page), which will verify that the original set of links is still valid from the original set. The 066' patent is a method which primarily focuses on detecting links that should either be allowed or dropped from the database.

Web site scanning is known. U.S. Pat. No. 6,615,259 to Nguyen et al describes a method and apparatus for scanning a web site in a distributed data processing system for problem determination. Web site scanning is initiated by a plurality of agents, wherein each of the plurality of agents is stationed at different locations in the distributed data processing system. Results of the scan are obtained from the plurality of agents. The results of the scan are analyzed to determine if a problem is associated with the web site.

While technologies that evaluate a site's known vulnerabilities have been around for some time, there is still a need for an invention that provides an automated tool for evaluating a Web site's exposure to potentially undiscovered vulnerabilities.

### SUMMARY OF THE INVENTION

A method or the method implemented in computer readable instructions generates a report that analyzes a website's data content and architecture and evaluates the inherent security exposure of the website. The report is related to a website in that the report allows the viewer of the report to understand the time and effort that must be utilized on an ongoing basis to ensure that the site is secure from emerging security threats

A method or the method implemented in computer readable instruction that include providing a risk score that characterizes exposure.

A method or the method implemented in computer readable instruction provides information needed by a user or system operator to understand how a hacker will attack a website.

A method or the method implemented in computer readable instruction that initially catalogs all relevant site related information. In turn, the method or the method implemented in computer readable instruction finds the “Attack Points”, or vectors of attack a hacker would use to hack into the site. The method or the method implemented in computer readable instruction then performs a calculation from this data to determine the relevant level of security exposure (e.g. none, low, medium, high).

A method or the method implemented in computer readable instruction only operating at Open Systems Interconnect (OSI) network application level 7 is provided.

A method or the method implemented in computer readable instruction for automated techniques that a manual application tester or user would use against a customized, dynamically generated web application.

A method for modeling a threat to a site is provided. The method includes the steps of: a) recording substantially all related information relevant to understanding how a hacker may attack the site; b) determining a set of attack points based upon the related information; c) giving each attack point a set of values; and d) performing a calculation based upon a set of values to determine a relevant level of security exposure for a particular attack point.

### BRIEF DESCRIPTION OF THE DRAWING

FIG. 1 shows block diagram of the present invention.

FIG. 2 shows a system of the present invention.

FIG. 3 shows a flowchart of the present invention.

FIG. 4 shows a diagram of the present invention.

### DETAILED DESCRIPTION OF THE INVENTION

In order to better understand the present invention, the following definitions or working definitions are listed in Table I below:

TABLE I
Definition of Terms

| | |
|---|---|
| Resource | typically a file on a web server that can create |
| | a web page. |
| Resource | characteristics of a resource. |
| Attributes | |
| Interactive | resources that perform a function of some kind (as |
| Resources | opposed to being a flat file on the web server). |
| Non-interactive | exemplified non-interactive resources are pages that |
| resources | contain static text and perhaps a few images and do not |
| | require the web server to do anything other than have the |
| | server feed the flat file to a browser. The user can not do |
| | anything to this flat file because the web server does not |
| | interact with anything. |
| Crawler | the part of a Spider program or search engine that |
| | searches data prior to vulnerability assessment. |

Resource may also be a JavaScript link that creates a page. Resources are not limited to files that comprise web pages. Resource may also be a configuration file or file that does not serve content, but rather performs some functions. All substantial resource “types” are listed below in Table II.

TABLE II
Exemplified Types of Resources

| | |
|---|---|
| 1 | HTML |
| 2 | Application content (e.g. PHP, ASP, Java, CFM, etc.) |
| 3 | JavaScript |
| 4 | Images |
| 5 | Text |
| 6 | Compressed files (e.g. zip, tar.gz, etc.) |
| 7 | Archive/backup files (e.g. .bak, etc.) |
| 8 | Log files |
| 9 | Database driven content (e.g. site.com/resource.php?resource= ) |
| 10 | Include files |

Resource attributes are a resource (web page) that may contain some images as well as content that come from a database which require a cookie in order to browse the page. In this example, three attributes are needed to catalog: images, a database connection, and a cookie. Further examples of resource attributes are listed below in Table III.

TABLE III
Examples of Resource Attributes

| | |
|---|---|
| 0 | URL/Form Parameters |
| 1 | Cookies |
| 2 | Forms |
| 3 | Email id |
| 4 | JavaScript functions |
| 5 | Authentication points |
| 6 | Query string (e.g. for a database) |
| 7 | Hidden fields |
| 8 | Comments |
| 9 | Scripts |
| 10 | Applets/Objects |

Examples of Interactive Resources include database driven content in which database driven content is “interactive” because it requires the web server to communicate with the database and retrieve something specific. An attacker typically focuses on Interactive Resources because they can modify the request the web server issues in order to attempt some form of attack by interacting with these backend systems that run the web site.

On the other hand, non-interactive resources are typically a page that contains static text and perhaps a few images. A non-interactive resource does not require the web server to do anything other than having the server feed the flat file to a browser. The user cannot do anything to this flat file because the web server does not interact with anything.

A crawler is responsible for, among other things, crawling the entire site. A crawler is the foundation for all scan activity since it provides data subject to further processing by the present invention. If the crawler can not build a proper catalog of all site contents, the present invention will not be able to do anything to it (i.e. attack it to perform a vulnerability assessment including the generation of a report).

### The Application Threat Modeling Process

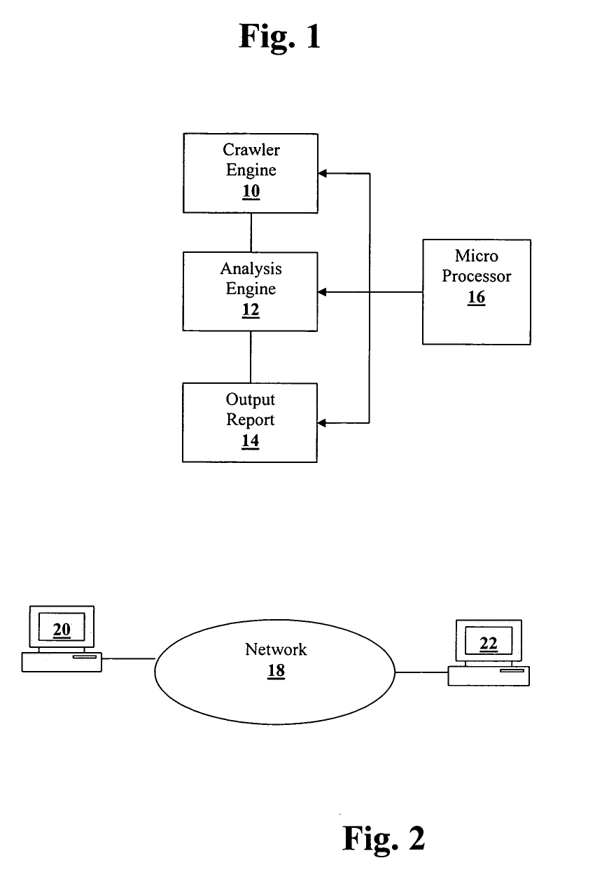

Referring to FIG. 1, the threat model begins with a crawling phase that uses an automated spidering engine 10 to actuate each link of the application. Links are identified through pattern recognition and parsing JavaScript of every response's HTML page. The engine 10 stores each link in memory and in an XML file.

Upon completion of the crawl, the spidering engine 10 passes the collected links to an analysis engine 12 that identifies attributes (e.g. attributes listed in Table III) that can be used to calculate exposure. Some of the attributes are cookies set by the “Set-Cookie” header, forms, hidden input fields, POST data, URL parameters, e-mail addresses, and HTML comments. The analysis engine 12 counts the raw number of attributes per link and the overall count for the application. Once the attributes have been identified, the exposure is then calculated. A report 14 is generated for analysis. The spidering engine and the analysis engine 12 may be controlled by a micro-controller 16.

Referring to FIG. 2, a network 18 such as the Internet or World Wide Web is provided. A first server 20, storing data relating to at least one web page, is coupled to network 18. Server 20 may comprise the present invention's method implemented in computer readable instructions. Typically, the present invention's method implemented in computer readable instructions is controlled by a second server 22 coupled to network 18, executing instructions by way of network 18.

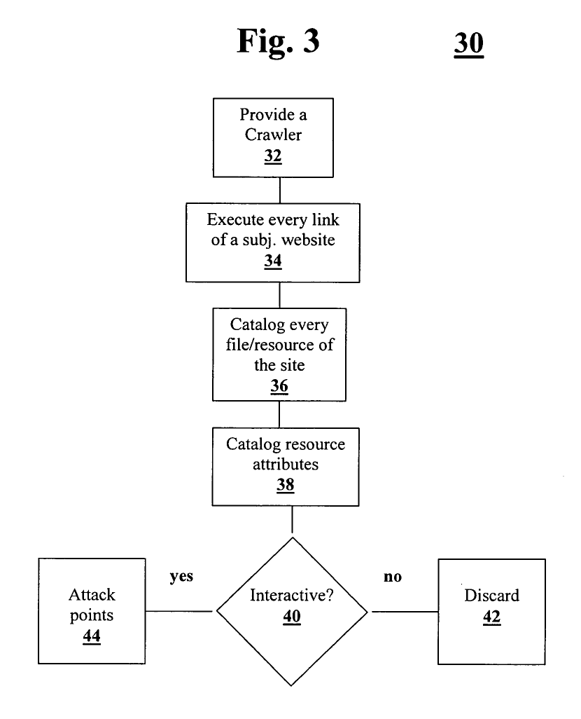

Referring to FIG. 3, a flowchart 30 of the present invention is shown. A crawler is provided to work on a site 32. Application Threat Modeling is determined substantially from the crawl data, and not any other vulnerability assessment (VA) data. Thus, the application threat modeling of the present invention is calculated based on the architecture of a crawled site as analyzed by the Crawler portion of Present invention. The crawler will essentially execute every link 34 on a web site to catalog every file/resource on the site 36. The crawler will also catalog the resource's attributes (as shown in Table III) relating to the site 38.

A determination is made as to whether the resource cataloged is interactive or static (non-interactive) 40. It then takes all the static, non-interactive resources and tosses them out 42. What is left is the interactive content, or what we call Attack Points 44. Attack Points 44 are resources that possess attributes that an attacker could interact with (targeting the web server, application server or database), such as a form field, a database connection or a hidden field.

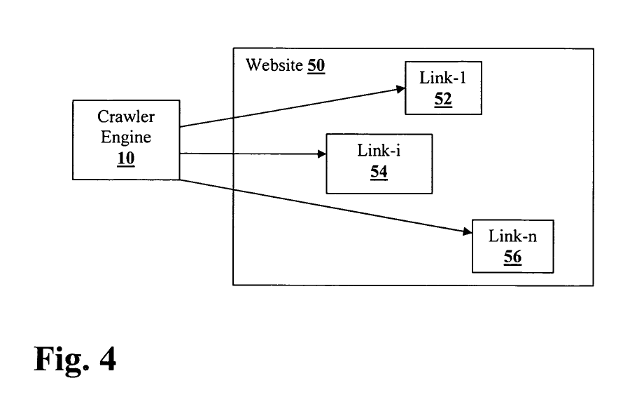

As shown in FIG. 4, crawler engine 10 essentially executes every link on a web site 50 to catalog every file/resource on the site 50. The link range from link-1 52 . . . to link-I 54 . . . to link-n 56.

One often refers to application threat modeling as a “qualitative analysis” of the target site. It does not contain any discrete vulnerability information (what is often called “quantitative analysis”), but rather focuses on the structure and content of the site and how that may have an impact on future, or emerging, security threats. This is what the present invention teaches.

A good example of why Attack Points 44 are a concern is shown with a site that has many form fields. While the application's processing of such form inputs may be secure at this time, any change to the site (such as a new application or a modification to one) could possibly introduce a form-based attack vulnerability. Additionally, a new attack could be devised so that it might affect form inputs that interact with such applications. Here we see that even though they may currently be secure, the sheer existence of such resources (i.e. form fields on a web page) creates a persistent concern that must be monitored and considered throughout the application life-cycle.

Additionally, the application threat modeling of the present invention allows security personnel to understand what their application security program should include to best secure their web sites. Since not all web sites have the same security exposure or security concerns, it is important to make sure that the organization is aligning their security programs with relevant security exposure. An exemplified technical explanation of the above using two types of web sites is shown below:
(a) An e-commerce site is likely to be heavily driven by databases and runs by utilizing many types of inputs. These inputs typically are not form data. In fact they are anything but form data, but rather may be the quantity of an item getting purchased to a price variable. The site applications must process these requests in order to perform the commerce function of selling things. However, if the site does not have a robust set of “input validation filters” it is possible that an attacker could modify input values to exploit the applications. This could result in purchasing an item for less money, one of other possible exploitations. These types of sites are highly dependent on input validation filters to prevent such attacks and, thus, are a suitable candidate for the application of the present invention.
(b) A very different site would be a company extranet that allows partners and vendors to obtain documents such as contracts or pricing information. This site most likely contains mostly flat files, thus inputting validation attacks may be entirely impossible. It is nonetheless critical that this site's data not fall into the wrong hands. Therefore, access to the site is important since it would create pressure to develop quality assurance (QA) and to utilize robust authentication and authorization and encryption techniques by restricting access to this data.

The above examples show us that not all sites are equally created. The application threat modeling of the present invention is designed to communicate this information so that a company's security, development, and QA teams may understand how their online business model is affected by such security threats. Simply put, the present invention gives them the information they need, but previously did not have in order to align their security related efforts of securing their web business.

The crawler also communicates with Response codes, Web server platforms, and External site links (including the data that is being sent via SSL and plaintext)

### Application Threat Modeling Security Exposure Calculation

As mentioned, once the Present invention has catalogued all the interactive site content and its attributes, it then performs a calculation to determine the extent of “security exposure”. It is critical to point out that this calculation is subjective in that different people have different preconceived notions regarding the security field. Therefore while a paranoid individual might find even the slightest bit of exposure to be an unacceptable threat, another individual might not care that 100% of the site can be hacked through an abundance of attack vectors.

The present invention creates a rudimentary exposure scoring calculation that provides a perceived level of security exposure. The exposure is correlated with otherwise unused information into report 14 which communicates or answers the questions of:
1. How much exposure to an attack does a site have?
2. What resources/attributes make up that exposure?
   With the above in mind, the exposure calculation is based on two things:
1. The ratio of Attack Points to non-Attack Points
2. The types of attackable resource attributes
   An application's exposure is calculated based on each attack point:

$$Exposure = Sum of ( Minimum ( APweight * APtotal ) , APceiling ) ) \\ or \\ Exposure = {\sum }_{i = 1}^{n} ( Min ( APweight * APtotal ) , APceiling ) \text{)} \qquad ( 1 )$$

Where for each type of attack point, the total number of points present in the application is denoted by (APtotal), which is multiplied by a weighting factor (APweight) that is predetermined by a user. An attack point can contribute no more than a maximum value (APceiling) to the exposure rating. The minimum value is chosen between the attack point's score and its ceiling. The sum of all attack point scores represents the exposure rating.

While other technologies may capture the above-mentioned data in many forms, some may capture only part of the data, and others may capture all of it. But the data is not the whole invention herein, but rather, it is the correlation of how the site construction does or does not create a security concern based upon a novel report 14 that correlates the parameters of a site automatically.

A human user or technician can perform the present invention. However, the present invention teaches an automatic process wherein human intervention during processing is not necessary. In other words, the present invention teaches a method of computer readable automatic data processing where no human operator is needed for generating the report 14 based upon equation 1.

Unlike prior art systems, such as the 737' patent that operates at OSI levels 4,5,6, the Web Application Scanner of the present invention operates at level 7 and generally only connects to the two web server ports (e.g. 80 and 443) in order to exercise the custom web application and the application's HTML pages. The present invention operates on a different network stack level, automating the manual input techniques an application tester would apply against the content of custom and dynamically generated HTML applications. In other words, the present invention does not test the level 6 input of the server.

The present invention is associated with a Web Application Scanner. A Web Application Scanner generally only connects to the two web server ports (e.g. 80 and 443) in order to exercise the custom web application that is accessed through it. The present invention only scans the web application content at level 7 of the network protocol stack and not the web server at layer 6 or lower. These packets for different levels are constructed differently and do not cross stack boundaries.

It is important to note that while the present invention has been described in the context of a fully functioning data processing system, those of ordinary skill in the art will appreciate that the processes of the present invention are capable of being distributed in a form of a computer readable medium of instructions in addition to a variety of other forms. Further, the present invention applies equally, regardless of the particular type of signal bearing media that is actually used to carry out the distribution. Examples of computer readable media include recordable-type media such a floppy disc, a hard disk drive, a RAM, a CD-ROM, a DVD-ROM, a flash memory card and transmission-type media such as digital and analog communications links, or wired or wireless communication links using transmission forms such as radio frequency and light wave transmissions. The computer readable media may take the form coded formats that are decoded for actual use in a particular data processing system.

Accordingly, it is to be understood that the embodiments of the invention herein described are merely illustrative of the application of the principles of the invention. Reference herein to details of the illustrated embodiments is not intended to limit the scope of the claims, which they themselves recite features regarded as essential to the invention.

What is claimed is:

1. A method for modeling a threat to a site, comprising the steps of:
a) recording substantially all related information relevant to understanding how a hacker may attack the site;
b) determining a set of attack points based upon said related information;
c) giving each attack point a set of values; and
d) performing a calculation based upon said set of values to determine a relevant level of security exposure for a particular attack point.

2. The method of claim 1 further comprising a summary of all of the given values.

3. The method of claim 1 further comprising a generation of an exposure report.

4. The method of claim 1, wherein said level of security comprises: none, low, medium, or high.
